(19) United States
(12) Patent Application Publication
(10) Pub. No.: US 2017/0079287 A1
(43) Pub. Date: Mar. 23, 2017

(54) GLUTEN-FREE BREAD

(71) Applicant: NESTEC S.A., Vevey (CH)

(72) Inventors: Koraljka Rade-Kukic, Savigny (CH); Luis Roberto King, Pully (CH); Hugo Gloria-Hernandez, Lausanne 26 (CH)

(21) Appl. No.: 15/310,608

(22) PCT Filed: May 8, 2015
(86) PCT No.: PCT/EP2015/060222

§ 371 Date: Nov. 11, 2016

(30) Foreign Application Priority Data
May 14, 2014 (EP) 14168210.4

(51) Int. Cl. A21D 13/06; A21D 2/26; A21D 2/18

(52) U.S. Cl. CPC A21D 13/066; A21D 2/186; A21D 2/266

(57) ABSTRACT

The present invention generally relates to gluten-free food products. In particular, the present invention concerns gluten-free bread comprising starch-containing material and Brassicaceae seed protein. Further aspects of the invention are a process for manufacturing gluten-free bread, a gluten-free food product and a gluten-free dough.

### FIELD OF THE INVENTION

The present invention generally relates to gluten-free food products. In particular, the present invention concerns gluten-free bread comprising starch-containing material and Brassicaceae seed protein. Further aspects of the invention are a process for manufacturing gluten-free bread, a gluten-free food product and a gluten-free dough.

### BACKGROUND OF THE INVENTION

Coeliac disease is a chronic inflammatory disorder of the small bowel induced in genetically susceptible people by the irritant gluten and possibly other environmental cofactors. [A. Di Sabatino et al., The Lancet, 373, 1480-1493 (2009)]. Coeliac disease is the most common lifelong dietary disorder worldwide, affecting around 1% of the European population and claimed to be “highly under-diagnosed in all countries” [K. Mustalahti et al., Annals of Medicine, 42, 587-595 (2010)]. A strict gluten-free diet remains the mainstay of safe and effective treatment. Gluten is a protein composite found in foods processed from wheat and related grain species, including barley and rye. In addition to suffers from coeliac disease, people who are gluten-intolerant or gluten sensitive are sometimes recommended or prescribed to follow a gluten-free diet. These may include people with Crohn's disease, ulcerative colitis, irritable bowel syndrome, dermatitis herpetiformis, or autism.

Replacing wheat flour in bakery products is a difficult challenge. The baking industry in most parts of the world is based on the unique properties of wheat flour, and manufacturing processes have been optimized around these properties. Furthermore, the desirable textures and flavours of bakery products have been built around wheat flour, with gluten playing a key role in determining the baking quality.

Breads make the most significant demands on gluten functionality of any bakery goods. In wheat breads, gluten confers absorption capacity, cohesiveness, viscosity and elasticity to the dough. Gluten plays a critical role in the development of cell structure and volume, dough development properties, mixing, rolling and baking. These properties are important for producing desirable attributes such as the ability to slice the bread, and have a strong influence on texture and sensory characteristics. Elimination of gluten from the flour base leads to serious defects in processing, cell structure and texture properties, including lack of volume, lack of elasticity, dryness and gumminess. The final product will also have significant defects in crumb structure, shelf life and stability [Y. L. Dar, Cereal Foods World, 58, 298-304 (2013)].

In an attempt to provide gluten-free bread with similar properties to gluten-containing bread, structure-building additives have been proposed. U.S. Pat. No. 4,451,491 proposes the use of additives such as xanthan gum, guar gum, locust-beam gum, alginate, pregelatinized starch and carboxymethylcellulose. These materials are hydrophilic and thus may require excessive amounts of water. During baking, the high water content leads to more fully pasted starch and in turn a more brittle, crumbly final texture and a shorter, less chewy bite. Replacing gluten with non-protein materials may also result in a product with a lower nutritional value.

EP2051588 discloses gluten-free bread comprising a starch, a gluten-free gas-retaining polymer such as butadiene-styrene rubber and a gluten-free setting polymer such as corn zein. However, synthetic ingredients such as butadiene-styrene rubber may not be popular with consumers.

U.S. Pat. No. 4,285,862 proposes a protein isolate as an egg white or wheat gluten substitute in a variety of food products. The protein isolate is an amorphous mass, termed a protein micellar mass. U.S. Pat. No. 4,285,862 describes a gluten-free bread comprising milk and a protein micellar mass obtained from pea or soy. The protein micellar mass is at level of around 13 wt. % on a dry basis.

Milk proteins, surimi proteins, soya proteins and egg proteins have all been proposed in gluten-free bakery products [A. Houben et al., Eur. Food Res. Technol, 235, 195-208 (2012)]. However, these proteins may be responsible for allergic reactions in some people. EP0642737 describes a gluten-free bread made by beating gluten-free flour with egg whites before baking. The beaten mixture of gluten-free flour and egg whites was proofed for 12 hours. Such long proofing times slow down production and hence add cost. Although the foaming properties of egg white may be used to provide volume, the texture produced is not bread-like, being sticky rather than elastic. A high quantity of egg white protein is also required, which leads to a pronounced egg taste.

Hence, there remains a need to provide gluten-free breads which match the properties of wheat breads more closely, provide good nutrition and contain ingredients which are attractive to the consumer. In addition, ingredients used to replace gluten should be relatively inexpensive and provide the desired functionality at a low level of addition so as to allow gluten-free bread to be manufactured at a low cost. Ideally, gluten-free bread formulations should be capable of being produced on standard bread production equipment, with similar processing times.

Several species of Brassicaceae or Cruciferae have become important agricultural crops around the world. Among these, canola or rapeseed (Brassica napus and Brassica rapa, formerly Brassica campestris), oriental and brown mustard (Brassica juncea), black mustard (Brassica nigra) and yellow mustard (Sinapis alba synonym Brassica hirta) are important in the global oilseed economy [J. P. D. Wanasundara, Critical Reviews in Food Science and Nutrition, 51, 635-677 (2011)]. A major commercial use of Brassicaceae seeds is the production of edible oils, but at present Brassicaceae seed proteins are primarily used for feeding livestock.

The nutritional quality of wheat protein is low in certain amino acids such as lysine. Mansour [E. H. Mansour et al., Acta Alimentaria, 28, 59-70 (1999)] reported adding canola protein to bread which contained wheat flour (and therefore gluten) in order to improve its nutritional profile. U.S. Pat. No. 8,535,907 describes the using canola protein concentrate to improve the nutritional content of foods including bread.

WO03/075673 describes using canola protein isolate as an egg replacer in food products; providing foaming properties in meringues, fat binding in doughnuts, and acting as a film-former to provide an edible coating on breads and buns.

An object of the present invention is to improve the state of the art and to provide an improved gluten-free bread to overcome at least some of the inconveniences described above, or at least to provide a useful alternative. The object of the present invention is achieved by the subject matter of the independent claims. The dependent claims further develop the idea of the present invention.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”.

The present invention provides in a first aspect a gluten-free bread comprising a gluten-free starch-containing material and between 0.5 and 15 wt. % Brassicaceae seed protein on a dry basis. In a second aspect, the invention relates to a gluten-free food product comprising the gluten-free bread of the invention. A third aspect of the invention relates to a process for manufacturing a gluten-free bread comprising preparing a gluten-free dough comprising between 30 to 50 wt. % water and, on a dry basis, 0.5 to 15 wt. % Brassicaceae seed protein, 50 to 90 wt. % starch, 0 to 8 wt. % yeast, 0 to 10 wt. % sugar, 0 to 10 wt. % oil and/or fat, and 0 to 3 wt. % salt and cooking the dough. A still further aspect of the invention is a gluten-free dough for making a gluten-free bakery product comprising between 30 and 50 wt. % water and, on a dry basis, 0.5 to 15 wt. % Brassicaceae seed protein, 25 to 90 wt. % starch, 0 to 8 wt. % yeast, 0 to 40 wt. % sugar, 0 to 30 wt. % oil or fat and 0 to 3 wt. % salt.

The inventors surprisingly found that by using Brassicaceae seed protein in gluten-free bread they could obtain a bread which had a structure and specific volume approaching that of gluten-containing breads, and better than some commercially available gluten-free breads. Without the addition of gums and emulsifiers, gluten-free bread comprising Brassicaceae seed protein provided similar specific volume to commercial gluten-free breads which did contain gums and emulsifiers.

### BRIEF DESCRIPTION OF THE FIGURES

FIG. 1 is a photograph of different breads from the examples formed as pizza bases.

FIG. 2 is a photograph of bread made with egg white (left-hand-side) and bread with a mixture of Canola and potato protein isolates (right-hand-side). Both breads have been lightly pressed, the depression remains on the bread made with egg white.

### DETAILED DESCRIPTION OF THE INVENTION

Consequently the present invention relates in part to a gluten-free bread comprising a gluten-free starch-containing material and between 0.5 and 15 wt. % Brassicaceae seed protein on a dry basis. The term gluten-free in the current specification refers to products with less than 20 ppm gluten, which is the definition from Codex Alimentarius Standard 118-1979. The starch-containing material may be starch itself, or it may for example be a non-gluten flour such as rice flour.

Removal of gluten from bread formulations in turn reduces the protein content and therefore the nutritional value of the bread. Using Brassicaceae seed protein as a gluten replacement, rather than for example gums and emulsifiers, provides a more nutritious gluten-free bread. As Brassicaceae seeds are generally grown for their oil, Brassicaceae seeds may provide an inexpensive source of protein as a by-product of oil production. It is therefore advantageous to be able to use Brassicaceae seed protein to manufacture gluten-free bread. In addition, acceptable breads can be obtained using low levels of Brassicaceae seed protein which may reduce the cost still further compared to other gluten substitute proteins. The gluten-free bread may comprise between 0.5 and 10 wt. % Brassicaceae seed protein on a dry basis, for example between 1 and 5 wt. % Brassicaceae seed protein on a dry basis.

The main component of traditional breads is starch. In a traditional wheat-based bread the starch is contained in wheat flour and it is the formation of a gluten-starch matrix which provides the desirable texture of bread. Other typical bread ingredients are oils and fats, salt and, for yeast-fermented breads, yeast. The gluten-free bread of the invention may comprise on a dry basis 0.5 to 15 wt. % Brassicaceae seed protein, 50 to 90 wt. % starch, 0 to 8 wt. % yeast, 0 to 10 wt. % sugar, 0 to 10 wt. % oil and/or fat and 0 to 3 wt. % salt. The sugar may be in many forms, for example crystalline sucrose, molasses or honey. The oil may be, for example, a vegetable oil such as sunflower oil or olive oil. The fat may be for example butter or margarine. The gluten-free bread of the current invention may also contain other ingredients such as such as spices, fruit (such as raisins), vegetables (such as onion), nuts (such as walnuts) or seeds (such as poppy). The term starch is used in the conventional manner to refer to a carbohydrate consisting of a large number of glucose units joined by glycosidic bonds. Starch does not contain gluten.

The starch-containing material comprised within the gluten-free bread of the invention may be gluten-free ground cereals, pulses, roots or mixtures of these. The gluten-free starch-containing material comprised within the gluten-free bread of the invention may be selected from the group consisting of maize starch, corn meal, buckwheat flour, millet flour, amaranth flour, quinoa flour, potato starch, sweet potato flour, tapioca starch, rice starch, rice flour, sorghum flour, bean flour, pea flour, pea starch, soy flour, chickpea flour, cowpea flour, lentil flour, bambara bean flour, lupin flour, chestnut flour and combinations of these. For example the starch-containing material may be a mixture of corn starch, potato starch and white rice flour, which mixture provides particularly good texture, moisture retention and final bread quality. For a darker colour, the gluten-free starch-containing material may be a mixture of corn starch, potato starch and brown rice flour. The gluten-free starch-containing material may be a mixture of tapioca starch, potato starch and rice flour. The gluten-free starch-containing material of the gluten-free bread of the invention may comprise between 30 and 50 wt. % flour. For example the gluten-free starch-containing material may contain between 10 and 30 wt. % corn starch, between 30 and 50 wt. % potato starch and between 30 and 50 wt. % rice flour. The gluten-free bread of the invention may comprise a natural source of non-starch polysaccharides such as from fruit, vegetable, cereal, pseudocereal or legume source. Adding non-starch polysaccharides fibre ingredients improves the bread texture by providing the textural attributes that would be provided by wheat fibre in conventional wheat-based bread. For example the non-starch polysaccharides may be gluten-free cereal bran, beet fibre, fruit pectin or pea fibre. To further enhance the nutritional value of the bread, the gluten-free bread of the invention may also comprise iron, folic acid, and other B vitamins.

Pentosans (polysaccharides composed of pentoses) have the undesirable effect in bread of binding water and preventing the dough from expanding fully, this leads to low bread volumes. Preferably the gluten-free bread of the invention is low in pentosans, for example the ratio of starch to pentosans may be greater than 30:1.

The Brassicaceae seed protein comprised within the gluten-free bread of the invention may be obtained from seeds selected from the group consisting of Brassica napus, Brassica rapa, Brassica juncea, Brassica nigra, Brassica hirta and combinations of these. The Brassicaceae seed protein may for example be rapeseed or canola protein. Canola is the Canadian oilseed crop developed primarily for the purpose of edible oil. It was naturally bred to reduce erucic acid in the oil and glucosinolates in the meal. The plants are cultivars of either rapeseed (Brassica napus) or field mustard/turnip rape (Brassica rapa). Recent cross-breeding of multiples lines of Brassica juncea have enabled this mustard variety to also be classified as a Canola variety. Canola is defined as seeds of the genus Brassica (Brassica napus, Brassica rapa or Brassica juncea) from which the oil shall contain less than 2% erucic acid in its fatty acid profile and the solid component shall contain less than 30 micromoles of any one or any mixture of 3-butenyl glucosinolate, 4-pentenyl glucosinolate, 2-hydroxy-3 butenyl glucosinolate, and 2-hydroxy-4-pentenyl glucosinolate per gram of air-dry, oil-free solid. Canola protein forms aggregates which mimic the rheological characteristics of hydrated gluten proteins making Canola protein particularly suitable as a gluten replacer in bread.

The Brassicaceae seed protein comprised within the gluten-free bread of the invention may be in the form of a protein isolate or a protein concentrate. Concentrates are typically considered to be between 40-89 wt. % protein on a dry basis, while 90 wt. % protein and above is considered as protein isolate. Protein isolates may be obtained from defatted Brassicaceae seeds by a number of extraction and purification processes, such as extraction with alkaline solution, enzymatic extraction, methods involving the formation of a protein micellar mass, salting out the protein with NaCl or combinations of these processes. Methods for obtaining Canola protein isolates are summarized by Tan [S. H. Tan et al., J Food Sci., 76, R16-R28 (2011)]. At least part of the Brassicaceae seed protein comprised within the gluten-free bread of the invention may be in its native form, for example at least 20 wt. % of the Brassicaceae seed protein comprised within the gluten-free bread of the invention may be in its native form.

Non-starch hydrocolloids are often used in gluten-free breads, acting to stabilize the bread. However, use of these materials may lead to a brittle, crumbly final texture. In addition, consumers are accustomed to the bread they eat being made from only a small number of preferably familiar ingredients and so it is beneficial that by using Brassicaceae seed protein as a gluten replacer the addition of non-starch hydrocolloids may be avoided. The gluten-free bread of the invention may be free from agar-agar, carrageenan, gum Arabic, tragacanth, locust bean gum, guar gum, cellulose derivatives and xanthan gum. The gluten-free bread of the invention may be free from modified starch; that is starch prepared by enzymatically, or chemically treating native starch, thereby altering its properties.

The gluten-free bread of the invention may comprise potato protein in addition to the Brassicaceae seed protein, for example the gluten-free bread of the invention may comprise potato protein isolate. The inventors have found that the addition of potato protein improves resistance to hardening on storage.

Milk proteins and egg proteins are used in a number of gluten-free bread recipes. Milk proteins in particular are able to build up a network structure similar to gluten. Unfortunately, some consumers are allergic to milk or egg proteins, or chose not to eat them due to their animal origin, e.g. vegans. It is therefore beneficial that, by using Brassicaceae seed protein as a gluten replacer, an acceptable bread may be obtained without the use of milk or egg proteins. The gluten-free bread of the invention may be free from milk protein and egg protein.

The gluten-free bread of the invention may be in various forms. The gluten-free bread may be leavened (aerated) or unleavened. It may be leavened by a number of different processes including the use of naturally occurring microbes, the addition of yeast, the addition of chemical leavening agents such as baking powder and baking soda, or high-pressure artificial aeration during preparation and/or baking. Western-style yeast-leavened bread with a very aerated structure is particularly difficult to make without the functionality of gluten, so it is beneficial that, by using Brassicaceae seed protein as a gluten replacer, an acceptable bread of this type may be obtained.

The gluten-free bread of the invention may have a high volume for its weight. For example the gluten-free bread of the invention may have a volume greater than 2.0 cm³/g, for example greater than 2.5 cm³/g, for example greater than 2.8 cm³/g, for further example greater than 3.0 cm³/g.

The gluten-free bread of the invention may be selected from the group consisting of pita bread, white bread, brown bread (e.g. made with endosperm and 10% bran), whole-grain bread (with non-gluten containing grains), roti, chapatti, naan, matzo, sourdough bread, flatbread and crisp bread. The gluten-free bread of the invention may be selected from the group consisting of pizza bases, focaccia and bread buns.

The gluten-free bread of the invention may be comprised within a gluten-free food product. For example the gluten-free bread may be sliced and placed around a filling as a sandwich, it may be in the form of croutons in soup, it may be as breadcrumbs coating a piece of meat or it may be the bread component of a bread and butter pudding. The gluten-free food product comprising the gluten-free bread of the invention may be a pizza.

In another aspect, the invention provides a process for manufacturing gluten-free bread, the process comprising preparing a gluten-free dough comprising between 30 to 50 wt. % water and, on a dry basis, 0.5 to 15 wt. % Brassicaceae seed protein, 50 to 90 wt. % starch, 0 to 8 wt. % yeast, 0 to 10 wt. % sugar, 0 to 10 wt. % oil and/or fat, and 0 to 3 wt. % salt and cooking the dough. The dough may be cooked by baking or any other of the methods known for cooking bread such as steaming, frying or microwaving. The term gluten-free dough means that the dough contains less than 20 ppm gluten. For example, none of the components of the dough may comprise gluten.

For breads leavened with yeast, a proofing step may be introduced. Proofing (also called proving) is the final dough-rise step in a yeast-fermented dough before baking, and refers to a period when the bread is left to rise. The process for manufacturing gluten-free bread may comprise preparing a gluten-free dough comprising between 30 to 50 wt. % water and, on a dry basis, 0.5 to 15 wt. % Brassicaceae seed protein, 50 to 90 wt. % starch, 0.5 to 8 wt. % yeast, 0 to 10 wt. % sugar, 0 to 10 wt. % oil and/or fat, and 0 to 3 wt. % salt, proofing the dough at a temperature of between 25° C. and 40° C. for at least 30 minutes and cooking the dough to form a bread.

In a further aspect, the invention provides a gluten-free dough for making gluten-free bread, the dough comprising between 30 and 50 wt. % water and, on a dry basis, 0.5 to 15 wt. % Brassicaceae seed protein, 50 to 90 wt. % starch, 0 to 8 wt. % yeast, 0 to 10 wt. % sugar, 0 to 10 wt. % oil and/or fat and 0 to 3 wt. % salt. Recent years have shown a growth in supermarkets and roadside service stations having small in-store bakeries which bake bread on the premises. Many of these in-store bakeries use ready-to-bake doughs, so the employees of the bakery do not need to prepare the bread dough themselves. Pre-made bread dough is also available for consumers to purchase and bake bread conveniently at home. Such ready-to-bake dough may be chilled or frozen to both prevent the growth of spoilage organisms and to prevent any bread yeast present from fermenting in storage. Chilled food is typically maintained at temperatures between 2 and 8° C. in storage and transit, while frozen food is typically maintained below −18° C. The gluten-free dough of the invention may be a chilled or frozen ready-to bake dough. For example the chilled or frozen ready-to bake dough may form the base of a chilled or frozen un-baked pizza.

Those skilled in the art will understand that they can freely combine all features of the present invention disclosed herein. In particular, features described for the products of the present invention may be combined with the process of the present invention and vice versa. Further, features described for different embodiments of the present invention may be combined. Where known equivalents exist to specific features, such equivalents are incorporated as if specifically referred to in this specification. Further advantages and features of the present invention are apparent from the figure and non-limiting examples.

### EXAMPLES

For examples 1 to 6, gluten-free bread comprising Brassicaceae seed protein was compared to a standard wheat flour bread recipe, two commercial gluten-free bread mixes and a negative control. For each recipe, two 250 g loaves were baked in loaf tins and 200 g was formed into a pizza base.

### Example 1

### Standard Bread with Wheat Flour

The following ingredients were mixed in a Hobart mixer with a hook element until complete development (dough forms thin film when stretched).

| Ingredient | g |
|---|---|
| wheat flour | 600 |
| Water | 400 |
| Yeast | 15 |
| Sugar | 10 |
| Salt | 10 |
| sunflower oil | 30 |
| Total | 1065 |

The dough was proofed for 30 minutes in a temperature controlled cabinet set at 37° C. and 85% relative humidity, then baked in an oven for 30 minutes at 180° C. The finished bread had a moisture content of 43%.

### Example 2

### Commercial Gluten-Free Bread “Dr Schär”

A gluten-free bread mix was purchased from a supermarket “Dr Schär bread mix”. The mix contains rice flour, potato starch, sugar, thickeners (hydroxypropyl methyl cellulose, locust bean gum), salt, mono- and diglycerides of fatty acids. The bread-making procedure indicated on the pack was followed. Water was added to the dry ingredients and mixed in a Hobart mixer with a hook element for 5 minutes.

| Ingredients | g |
|---|---|
| “Dr Schär” bread mix | 500 |
| Water | 500 |
| Yeast | 10 |
| Salt | 5 |
| sunflower oil | 6 |
| Total | 1021 |

The dough was proofed for 30 minutes in a temperature controlled cabinet set at 37° C. and 85% relative humidity, then baked in an oven for 50 minutes at 200° C. (to be consistent with the on-pack instructions). The finished bread had a moisture content of 53%.

### Example 3

### Commercial Gluten-Free Bread “aha”

A gluten-free bread mix was purchased from a Migros supermarket “aha Gluten-free flour mix”. The mix contains rice flour, potato starch, buckwheat flour, corn flour, corn starch, fructose and guar gum. The bread-making procedure indicated on the pack was followed. The following ingredients were mixed in a Hobart mixer with a hook element for 8 minutes.

| Ingredients | g |
|---|---|
| “aha” flour mix | 500 |
| Water | 350 |
| Yeast | 7 |
| Sugar | 5 |
| Salt | 7.5 |
| sunflower oil | 26 |
| Total | 895.5 |

The dough was proofed for 25 minutes in a temperature controlled cabinet set at 37° C. and 85% relative humidity, then baked in an oven for 35 minutes at 200° C. (to be consistent with the on-pack instructions). The finished bread had a moisture content of 43%.

### Example 4

### Gluten-Free Bread with Brassicaceae Seed Protein

Canola protein isolate (Isolexx™—91.4% protein) was purchased from BioExx Specialty Proteins Ltd. The following ingredients were used to form a bread.

| Ingredients | g |
|---|---|
| Canola protein isolate (Isolexx ™) | 15 |
| Water | 421 |
| corn starch | 117 |
| potato starch | 234 |
| white rice flour | 234 |
| Yeast | 15 |
| Sugar | 10 |
| Salt | 10 |
| sunflower oil | 30 |
| Total | 1086 |

The canola protein isolate was dispersed in 200 g of the water and the sunflower oil was added. The other dry ingredients were then mixed in a Hobart mixer and the canola dispersion was gradually added, followed by the remaining water (to allow adjustment of the mix consistency if required). The dough was proofed for 40 minutes in a temperature controlled cabinet set at 37° C. and 85% relative humidity, then baked in an oven for 30 minutes at 190° C. The finished bread had a moisture content of 44%, a canola protein isolate content of 2.5 wt. % on dry basis and a starch content of about 80 wt. % on a dry basis.

The recipe was repeated, but with tapioca starch replacing corn starch. This also gave good results, and provided improved resistance to staling.

### Example 5

### Negative Control

Example 4 was repeated but with no canola protein isolate present. The finished bread had a moisture content of 44%.

### Example 6

The specific volume after baking and cooling to room temperature was measured by a laser scanner (BVM, Perten Instruments) as the average of two measurements. The texture of the different breads was assessed using a TA-HD texture analyser, using a Texture Profile Analysis macro (compression with a cylindrical probe, the pre-test and post-test speed was 2.0 mm/s, test speed was 1.0 mm/s, distance 8 mm and the load cell was 5 kg). The hardness after baking and cooling to room temperature of bread slices of 2 cm thickness was assessed as the force in Newtons needed to produce a deformation of 40% of the initial height. The measurement was repeated 6 times and the average of the 5 closest was taken. Results are shown in the table below.

| | |
|---|---|
| Specific | |
| volume | Hardness |

| Example | | cm³/g | Force[N] | std dev |
|---|---|---|---|---|
| 1 | Wheat flour | 4.13 | 1.9 | 0.1 |
| 2 | Dr Schär | 2.98 | 1.9 | 0.3 |
| 3 | Aha | 1.53 | 29.8 | 4.9 |
| 4 | Canola protein | 3.03 | 1.4 | 0.3 |
| 5 | Negative Control | 2.72 | 2.7 | 0.1 |

The specific volume is linked to the capacity of the dough to retain gas cells created during mixing and expanded during fermentation (proofing). This is an important function of gluten proteins in a gluten-containing bread. The bread made with wheat flour had the highest specific volume. Of the gluten-free breads, the highest specific volume was the gluten-free bread made with canola protein (a Brassicaceae seed protein) which was comparable to the gluten-free bread made with commercial Dr Schär bread mix (containing locust bean gum, cellulose derivatives and emulsifiers).

The hardness of the bread is linked to the porosity of the structure and the thickness of cell walls. Gluten-based breads usually have a higher porosity and thinner cell walls, leading to a softer texture. Of the breads tested, the gluten-free bread made with canola protein was the softest.

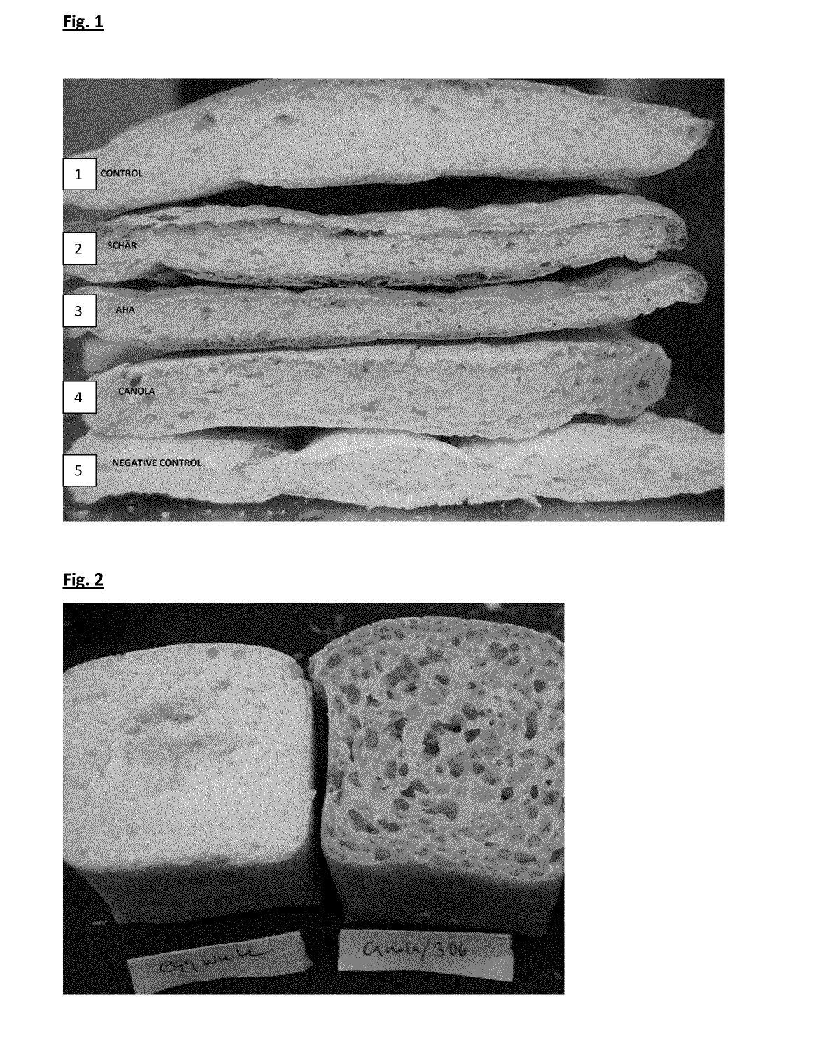

As can be seen in FIG. 1, the gluten-free bread made with canola protein has a macroscopic structure similar to that of the wheat bread.

### Example 7

### Gluten-Free Bread with Brassicaceae Seed Protein and Potato Protein

The following ingredients were used to form a bread.

| Ingredients | g |
|---|---|
| Canola protein isolate (Isolexx ™) | 10 |
| Potato protein isolate | 5 |
| Water | 421 |
| corn starch | 117 |
| potato starch | 234 |
| white rice flour | 234 |
| Yeast | 15 |
| Sugar | 10 |
| Salt | 10 |
| sunflower oil | 30 |
| Total | 1086 |

Potato protein was obtained from Solanic (Potato Protein Isolate 306). The canola protein isolate and potato protein isolate were dispersed in 200 g of the water and the sunflower oil was added. The other dry ingredients were then mixed in a Hobart mixer and the protein dispersion was gradually added, followed by the remaining water (to allow adjustment of the mix consistency if required). The dough was proofed for 40 minutes in a temperature controlled cabinet set at 37° C. and 85% relative humidity, then baked in an oven for 30 minutes at 190° C.

For comparison, the same recipe was made up but with egg white powder as the protein.

| Ingredients | g |
|---|---|
| Egg white powder | 15 |
| Water | 421 |
| corn starch | 117 |
| potato starch | 234 |
| white rice flour | 234 |
| Yeast | 15 |
| Sugar | 10 |
| Salt | 10 |
| sunflower oil | 30 |
| Total | 1086 |

The egg white powder was made up in 200 g of the water and the sunflower oil was added. The other dry ingredients were then mixed in a Hobart mixer and the protein dispersion was gradually added, followed by the remaining water (to allow adjustment of the mix consistency if required). The dough was proofed for 48 minutes in a temperature controlled cabinet set at 37° C. and 85% relative humidity, then baked in an oven for 30 minutes at 190° C.

The gluten-free bread made with canola and potato protein had a good bread texture, similar to that obtained with wheat flour and a specific volume of 2.95 cm³/g. The bread made with egg white had a strong taste, rather like an egg-white omelet, and a sticky texture, not desirable in bread. It had a specific volume of 2.49 cm³/g. After pressing the bread gently with fingers, the canola and potato protein bread sprang straight back, whereas the depression in the surface of the bread made with egg remained (FIG. 2). This confirmed that egg white proteins do not have the required functionality to produce a gluten-free bread with a texture similar to that of a gluten containing bread.

1. Gluten-free bread comprising a gluten-free starch-containing material and between 0.5 and 15 wt. % Brassicaceae seed protein on a dry basis.

2. Gluten-free bread according to claim 1 comprising on a dry basis 0.5 to 15 wt. % Brassicaceae seed protein, 50 to 90 wt. % starch, 0 to 8 wt. % yeast, 0 to 10 wt. % sugar, 0 to 10 wt. % oil, 0 to 10 wt. % fat and 0 to 3 wt. % salt.

3. Gluten-free bread according to claim 1 wherein the starch-containing material is selected from the group consisting of maize starch, corn meal, buckwheat flour, millet flour, amaranth flour, quinoa flour, potato starch, sweet potato flour, tapioca starch, rice starch, rice flour, sorghum flour, bean flour, pea flour, pea starch, soy flour, chickpea flour, cowpea flour, lentil flour, bambara bean flour, lupin flour, chestnut flour and combinations thereof.

4. Gluten-free bread according to claim 1 wherein the Brassicaceae seed protein is obtained from seeds selected from the group consisting of Brassica napus, Brassica rapa, Brassica juncea, Brassica nigra, Brassica hirta and combinations thereof.

5. Gluten-free bread according to claim 1 wherein the Brassicaceae seed protein is selected from the group consisting of rapeseed and canola protein.

6. Gluten-free bread according to claim 1 wherein the Brassicaceae seed protein is selected from the group consisting of a protein isolate and a protein concentrate.

7. Gluten-free bread according to claim 1 which is free of agar-agar, carrageenan, gum Arabic, tragacanth, locust bean gum, guar gum, cellulose derivatives and xanthan gum.

8. Gluten-free bread according to claim 1 which is free from milk protein and egg protein.

9. Gluten-free bread according to claim 1 which is selected from the group consisting of pizza bases, focaccia and bread buns.

10. Gluten-free food product comprising a gluten-free bread comprising a gluten-free starch-containing material and between 0.5 and 15 wt. % Brassicaceae seed protein on a dry basis.

11. Gluten-free food product according to claim 10 which is a pizza.

12. Process for manufacturing gluten-free bread, the process comprising
preparing a gluten-free dough comprising between 30 to 50 wt. % water and, on a dry basis, 0.5 to 15 wt. % Brassicaceae seed protein, 50 to 90 wt. % starch, 0 to 8 wt. % yeast, 0 to 10 wt. % sugar, 0 to 10 wt. % oil, 0 to 10 wt. % fat, and 0 to 3 wt. % salt; and
cooking the dough.

13. Process for manufacturing gluten-free bread according to claim 12, the process comprising:
preparing a gluten-free dough comprising between 30 to 50 wt. % water and, on a dry basis, 0.5 to 15 wt. % Brassicaceae seed protein, 50 to 90 wt. % starch, 0.5 to 8 wt. % yeast, 0 to 10 wt. % sugar, 0 to 10 wt. % oil, 0 to 10 wt. % fat, and 0 to 3 wt. % salt;
proofing the dough at a temperature of between 25° C. and 40° C. for at least 30 minutes; and
cooking the dough to form a bread.

14. Gluten-free dough for making gluten-free bread, the dough comprising between 30 and 50 wt. % water and, on a dry basis, 0.5 to 15 wt. % Brassicaceae seed protein, 50 to 90 wt. % starch, 0 to 8 wt. % yeast, 0 to 10 wt. % sugar, 0 to 10 wt. % oil, 0 to 10 wt. % fat and 0 to 3 wt. % salt.

15. Gluten-free dough according to claim 14 wherein the dough is a chilled or frozen ready-to bake dough.
